(19) United States
(12) Patent Application Publication
(10) Pub. No.: US 2013/0144719 A1
(43) Pub. Date: Jun. 6, 2013

(54) USING IMAGE MATCH TECHNOLOGY TO IMPROVE IMAGE ADVERTISEMENT QUALITY

(71) Applicants: Boon-Lock Yeo, Los Altos Hills, CA (US); Li Gangjiang, Shanghai (CN)

(72) Inventors: Boon-Lock Yeo, Los Altos Hills, CA (US); Li Gangjiang, Shanghai (CN)

(21) Appl. No.: 13/750,552

(22) Filed: Jan. 25, 2013

Related U.S. Application Data
(63) Continuation of application No. PCT/CN2011/079795, filed on Sep. 19, 2011.
Application No. PCT/CN2011/079795 is a continuation-in-part of application No. PCT/CN2011/078454, filed on Aug. 16, 2011.

(51) Int. Cl. G06Q 30/02

(52) U.S. Cl. CPC G06Q 30/0256
USPC 705/14.54

(57) ABSTRACT

Methods, systems, and apparatus, including computer programs encoded on a computer storage medium, providing advertising content to a user in response to an image search request to be performed on the Internet. A search phrase is input to be used to perform the image search on the Internet. Searching of Internet content is performed to identify content matching the received search phrase. Images associated with each of the matching content are compared with images associated with advertisements stored in an advertisement database, to determine which advertisements have associated images related to any of the images associated with the matching content. Based on display data provided to the client computer, each of the matching content can thus be displayed at a client computer with associated images, along with an advertisement having an associated image related to any of the matching content.

### CROSS-REFERENCE TO RELATED PATENT APPLICATIONS

This application is a continuation of International Application Patent Application No. PCT/CN/2011/079795, entitled “Using Image Match Technology to Improve Image Advertisement Quality,” filed Sep. 19, 2011, incorporated herein by reference in its entirety, and of International Patent Application No. PCT/CN2011/078454, entitled “Using Image Match Technology to Improve Image Advertisement Quality,” filed Aug. 16, 2011, incorporated herein by reference in its entirety.

### BACKGROUND

The Internet provides access to a wide variety of content. For instance, images, audio, video, and web pages for a myriad of different topics are accessible through the Internet. The accessible content provides an opportunity to place advertisements. Advertisements can be placed within content, such as a web page, image or video, or the content can trigger the display of one or more advertisements, such as presenting an advertisement in an advertisement slot and/or in a pop-up window.

Advertisers decide which ads are displayed within particular content using various advertising management tools. These tools also allow an advertiser to track the performance of various ads or ad campaigns. The parameters used to determine when to display a particular ad can also be changed using advertising management tools.

### SUMMARY

In general, one innovative aspect of the subject matter described in this specification can be embodied in a method for providing advertising content to a user in response to an image search request to be performed on the Internet, which includes receiving a search input to be used to perform the image search on the Internet; performing searching of Internet content to identify content matching the received search phrase; comparing images associated with each of the matching content with images associated with advertisements stored in an advertisement database, to determine which advertisements have associated images related to any of the images associated with the matching content; and providing display data used for displaying each of the matching content with associated images, along with an advertisement having an associated image related to any of the matching content.

Other embodiments of this aspect include corresponding systems, apparatus, and computer readable-media, configured to perform the actions of this method. These and other embodiments can each optionally include one or more of the following features:

displaying each advertisement at a client computer together with the associated matching content by displaying at least two separate user input fields that can be selected by the user in the vicinity of the image associated with the matching content, one user input field corresponding to an Internet address of the matching content and the other user input field corresponding to the web site that provided the associated advertisement for storage in the advertisement database.

Particular embodiments of the subject matter described in this specification can be implemented so as to realize one or more of the following advantages, or other advantages: a) increased revenue for advertisers due to users performing Internet searches selecting advertisements; and b) increased revenue for companies providing Internet search engines due to users selecting relevant advertisements provided with search results.

### BRIEF DESCRIPTION OF THE DRAWINGS

The details of one or more embodiments of the subject matter described in this specification are set forth in the accompanying drawings and the description below. Other features, aspects, and advantages of the subject matter will become apparent from the description, the drawings, and the claims.

FIG. 1 is a block diagram of an example environment in which advertisement images and search result images are combined and provided on a display consistent with an illustrative embodiment.

FIG. 2 shows an image search results and image advertisements display.

FIG. 3 shows an example of an image search results and an image advertisements display consistent with an illustrative embodiment.

FIG. 4 is a flow chart showing example operations carried out consistent with an illustrative embodiment.

FIG. 5 is a block diagram showing example elements of a real-time image advertisement and image search results comparing and displaying system consistent with an illustrative embodiment.

FIG. 6 is a block diagram showing example elements of a non-real-time image advertisement and image search results comparing and displaying system consistent with an illustrative embodiment.

FIG. 7 is a block diagram showing an example of how a query image can be compared with stored images to determine which ones match the query image, consistent with illustrative embodiments.

FIG. 8 is a block diagram of an example of a computer system consistent with an illustrative embodiment.

Like reference numbers and designations in the various drawings indicate like elements.

### DETAILED DESCRIPTION

Many users of the Internet employ search engines to search for particular information. When a user is provided with the search results, relevant advertisements can be provided together with the search results in a convenient, easy-to-read-and-select manner, so as to maximize revenue for advertisers who pay search engines for the right to display their advertisements together with the search results to users.

The present specification is directed to an internet advertisement providing system, method and computer program product, which enables image advertisements, such as ones provided by an advertisement-providing third party application, to be included with online search engine results. This may be performed so as to increase advertisement click revenue for the advertiser and to provide revenue for the provider of the online search engine.

As used throughout this document, user interactions are any presentation of content to a user and any subsequent affirmative actions or non-actions (collectively referred to as “actions” unless otherwise specified) that a user takes in response to presentation of content to the user (e.g., selections of the content following presentation of the content, or no selections of the content following the presentation of the content). Thus, a user interaction does not necessarily require a selection of the content (or any other affirmative action) by the user.

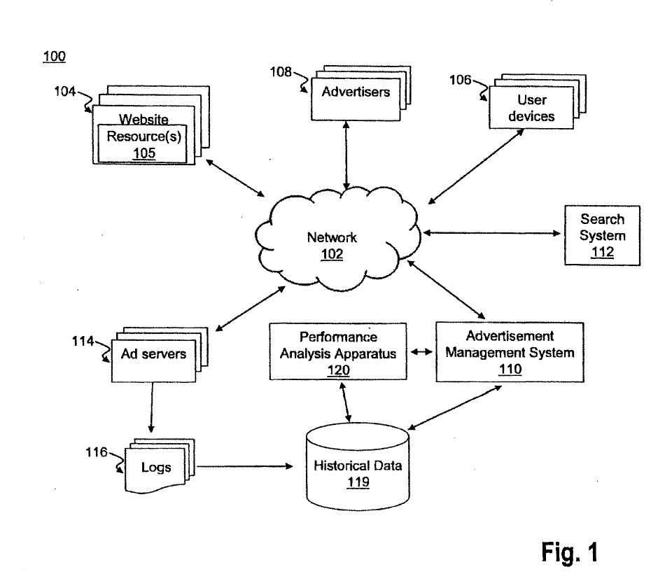

FIG. 1 is a block diagram of an example environment in which an advertisement management system manages advertising services in accordance with an illustrative embodiment. The example environment 100 includes a network 102, such as a local area network (LAN), a wide area network (WAN), the Internet, or a combination thereof. The network 102 connects websites 104, user devices 106, advertisers 108, and an advertisement management system 110. The example environment 100 may include many thousands of websites 104, user devices 106, and advertisers 108.

A website 104 is one or more resources 105 associated with a domain name and hosted by one or more servers. An example website is a collection of web pages formatted in hypertext markup language (HTML) that can contain text, images, multimedia content, and programming elements, such as scripts.

A resource 105 is any data that can be provided over the network 102. A resource 105 is identified by a resource address that is associated with the resource 105, such as a uniform resource locator (URL). Resources include web pages, word processing documents, portable document format (PDF) documents, images, video, programming elements, interactive content, and feed sources, to name only a few. The resources can include content, such as words, phrases, images and sounds, that may include embedded information (such as meta-information in hyperlinks) and/or embedded instructions (such as JavaScript™ scripts).

A user device 106 is an electronic device that is under control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can include data specifying a portion of the resource or a portion of a user display (e.g., a presentation location of a pop-up window or in a slot of a web page) in which advertisements can be presented. These specified portions of the resource or user display are referred to as advertisement slots.

To facilitate searching of the vast number of resources 105 accessible over the network 102, the environment 100 can include a search system 112 that identifies the resources 105 by crawling and indexing the resources provided on the websites 104. Data about the resources can be indexed based on the resource with which the data is associated. The indexed and, optionally, cached copies of the resources are stored in a search index (not shown).

User devices 106 can submit search queries to the search system 112 over the network 102. In response, the search system 112 accesses the search index to identify resources that are relevant to the search query. In one illustrative embodiment, a search query includes one or more keywords. The search system 112 identifies the resources in the form of search results and returns the search results to the user devices 106 in search results pages. A search result is data generated by the search system 112 that identifies a resource that is responsive to a particular search query, and includes a link to the resource. An example search result can include a web page title, a snippet of text or a portion of an image extracted from the web page, a rendering of the resource, and the URL of the web page. Search results pages can also include one or more advertisement slots in which advertisements can be presented.

A search result page can be sent with a request from the search system 112 for the web browser of the user device 106 to set an HTTP (HyperText Transfer Protocol) cookie. A cookie can represent, for example, a particular user device 106 and a particular web browser. For example, the search system 112 includes a server that replies to the query by sending the search results page in an HTTP response. This HTTP response includes instructions (e.g., a set cookie instruction) that cause the browser to store a cookie for the site hosted by the server or for the domain of the server. If the browser supports cookies and cookies are enabled, every subsequent page request to the same server or a server within the domain of the server will include the cookie. The cookie can store a variety of data, including a unique or semi-unique identifier. The unique or semi-unique identifiers are anonymized and are not connected with user names. Because HTTP is a stateless protocol, the use of cookies allows an external service, such as the search system 112 or other system, to track particular actions and status of a user over multiple sessions. A user may, at any time, opt out of tracking user actions, for example, by disabling cookies in the browser's settings.

When a resource 105 or search results are requested by a user device 106, the advertisement management system 110 receives a request for advertisements to be provided with the resource 105 or search results. The request for advertisements can include characteristics of the advertisement slots that are defined for the requested resource or search results page, and can be provided to the advertisement management system 110. For example, a reference (e.g., URL) to the resource for which the advertisement slot is defined, a size of the advertisement slot, and/or media types that are available for presentation in the advertisement slot can be provided to the advertisement management system 110. Similarly, keywords (i.e., one or more words that are associated with content) associated with a requested resource (“resource keywords”) or a search query for which search results are requested can also be provided to the advertisement management system 110 to facilitate identification of advertisements that are relevant to the resource or search query.

Using data included in the request for advertisements, the advertisement management system 110 can select advertisements that are eligible to be provided in response to the request (“eligible advertisements” or “candidate advertisements”). For example, eligible advertisements can include advertisements having characteristics matching the characteristics of advertisement slots and that are identified as relevant to specified resource keywords or search queries. In some implementations, advertisements having targeting keywords that match the resource keywords or the search query are selected as eligible advertisements by the advertisement management system 110.

The advertisement management system 110 selects an eligible advertisement for each advertisement slot of a resource 105 or of a search results page. The resource 105 or search results page is received by the user device 106 for presentation by the user device 106. User interaction data representing user interactions with presented advertisements can be stored in an historical data store 119. For example, when an advertisement is presented to the user via an ad server 114, data can be stored in a log file 116. This log file 116, as more fully described below, can be aggregated with other data in the historical data store 119. Accordingly, the historical data store 119 contains data representing the advertisement impression. For example, the presentation of an advertisement is stored in response to a request for the advertisement that is presented. For example, the ad request can include data identifying a particular cookie, such that data identifying the cookie can be stored in association with data that identifies the advertisement(s) that were presented in response to the request. In some implementations, the data can be stored directly to the historical data store 119.

Similarly, when a user selects (i.e., clicks) a presented advertisement, data can be stored in the log 116 or the historical data store 119 representing the selection of the advertisement. In some implementations, the data is stored in response to a request for a web page that is linked to by the advertisement. For example, the user selection of the advertisement can initiate a request for presentation of a web page that is provided by (or for) the advertiser. The request can include data identifying the particular cookie for the user device, and this data can be stored in the advertisement data store.

User interaction data can be associated with unique identifiers, each representing a corresponding user device with which the user interactions were performed. For example, in some implementations, user interaction data can be associated with one or more cookies. Each cookie can include content that specifies an initialization time that indicates a time at which the cookie was initially set on the particular user device 106.

The logs 116 or the historical data store 119 also store references to advertisements and data representing conditions under which each advertisement was selected for presentation to a user. For example, the historical data store 119 can store targeting keywords, bids, and other criteria with which eligible advertisements are selected for presentation. Additionally, the historical data store 119 can include data that specifies a number of impressions that each advertisement has received, and the number of impressions for each advertisement can be delineated, for example, using the keywords that caused the advertisement to receive impressions and/or the cookies that are associated with the impressions.

Data for each impression can also be stored so that each impression and user selection can be associated with (i.e., stored with references to and/or indexed according to) the advertisement that was selected and/or the targeting keyword that caused the advertisement to be selected for presentation. The advertisers 108 can submit, to the advertisement management system 110, campaign parameters (e.g., targeting keywords and corresponding bids) that are used to control distribution of advertisements. The advertisers 108 can access the advertisement management system 110 to monitor performance of the advertisements that are distributed using the campaign parameters. For example, an advertiser can access a campaign performance report that provides a number of impressions (i.e., presentations), selections (i.e., clicks), and conversions that have been identified for the advertisements.

The campaign performance report can also provide a total cost, a cost-per-click, and other cost measures for the advertisement over a specified period of time. For example, an advertiser may access a performance report that specifies that advertisements distributed using the phrase match keyword “hockey” have received 1,000 impressions (i.e., have been presented 1,000 times), have been selected (e.g., clicked) 20 times, and have been credited with 5 conversions. Thus, the phrase match keyword “hockey” can be attributed with 1,000 impressions, 20 clicks, and 5 conversions.

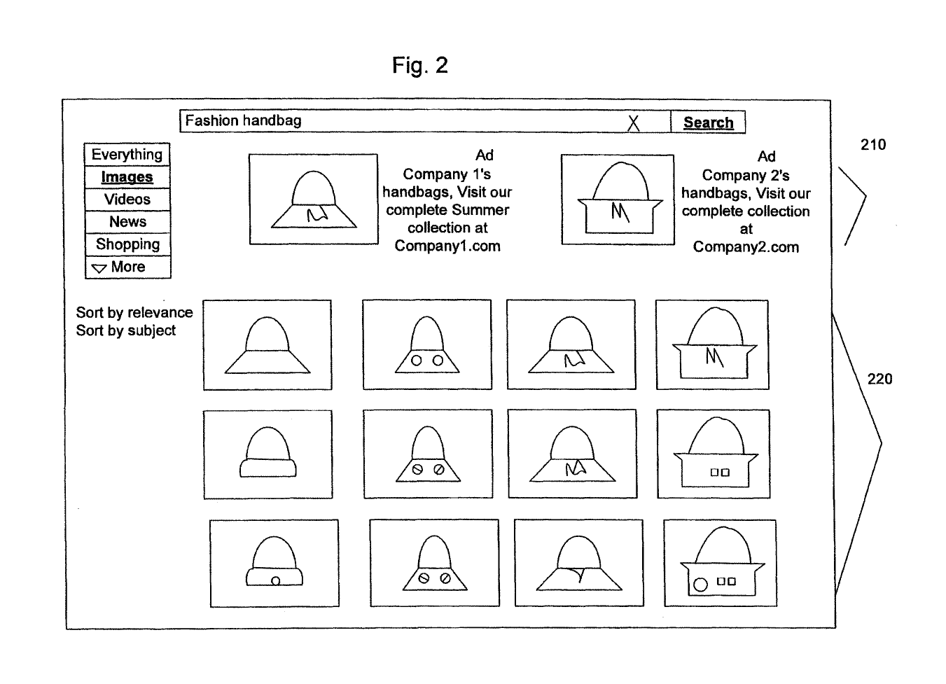

Modern search advertisements not only include text, but also sometimes include an image. The advertisement, including the image, may be related to the search query directly. For example, FIG. 2 shows a display 200 of search results and advertisements, in which the advertisements are provided on a portion 210 of the display above a portion 220 providing image search results. In this case, the search term “fashion handbags” using an image searching option (e.g., effected by selection of an Images link) comes up with many images of handbags obtained from online web pages, and relevant “fashion handbag” advertisements are provided above the image search results.

Typically, the fashion handbag advertisements do not deliberately correlate to the handbag image search results, and so the advertisements are less useful to the user and the user has less interest to click on any of the advertisements.

In an illustrative embodiment, image matching technology is used to match similar advertisement images to search result images, and to combine any matched or closely-matched images when displayed to the user. Image matching technology may quickly and very precisely match images to one another, using image feature vector processing, digital signal processing techniques, and the like. The use of such techniques provides a way to quickly and conveniently combine advertisement images with search result images to provide a display in which a user can conveniently select a relevant image advertisement associated with a particular image search result.

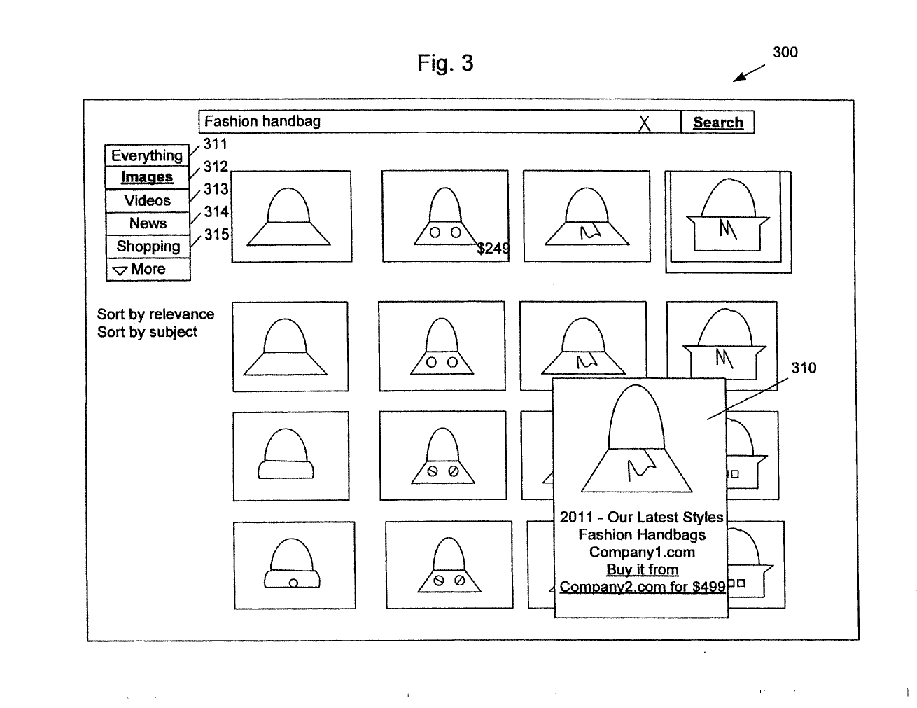

In more detail, if an image match is found with respect to a search result image and an image associated with an advertisement stored in an advertisement database, those images are tagged for inclusion together on a search result display to the user. FIG. 3 shows such an image search results display, in which an image associated with the “fashion handbag” search term was found at the Company1.com Internet site, and in which a matching image provided by another company (Company2) was found in an advertisement database. In this case, the URL of Company2, shown in FIG. 3 as Company2.com, is included together with the URL of the image search result, shown in FIG. 3 as Company1.com. By providing such a display 300 to the user, the user can conveniently select either the advertisement user input field (shown in FIG. 3 as a URL) or the search result user input field (shown in FIG. 3 as a URL) to get further information on (and possibly purchase) the fashion handbag shown in the accompanying image.

Price information may be included with the image, if such information is included with the image stored in the advertisement database. In this case, the advertisement database includes information indicating that the particular handbag shown in the image sells for “$499”, and so that information is also provided on or near the URL associated with the advertiser Company2. Alternatively, the price can be displayed somewhere near or on the advertisement image (e.g., on the pop-up window). As shown in FIG. 3, the third handbag image in the first row is shown with a price of $249, which would indicate to the user that this particular handbag has a corresponding advertisement image that matches the search image.

When the user moves his/her mouse over an image on the search results display of FIG. 3, the detailed information of the URL of the advertiser (if one exists) and the URL of where the image was obtained are provided in an embedded popup window 310, along with other pertinent information associated with the image (as obtained from the advertisement database and/or from the URL of where the image was obtained). Search key words associated with “fashion handbag” for online web pages would typically be used in obtaining relevant search result information to the user.

In FIG. 3, the user can either click on the URL of where the image obtained from the search was obtained, Company1.com, or the user can click on the URL of the corresponding advertisement having an image that matches the online search results image, or not click on either one. By placing the relevant advertisement URL right next to the associated search result images on the display 300, a user is more likely to click on the advertisement URL and purchase the image from the advertiser, and thus provide revenue for the advertiser and the search engine that associated advertisement images with search result images. In various alternatives, advertisement data (a URL, a video advertisement, an image advertisement, a price, or other ad data) may be provided anywhere on the web page (e.g., in an advertisement bar or portion such as portion 210 in FIG. 2, in a pop-up window such as window 310 near the image result, close to or in the vicinity of either the searched image or the advertisement image, or at any other location on the page relative to the location of the searched image and/or the advertisement image, etc.). In one advantageous embodiment, advertisement data may be provided in a location based on the location of at least one of the searched image or advertisement image (e.g., in the vicinity of the image, between the two images, in a same pop-up window as the image, etc.).

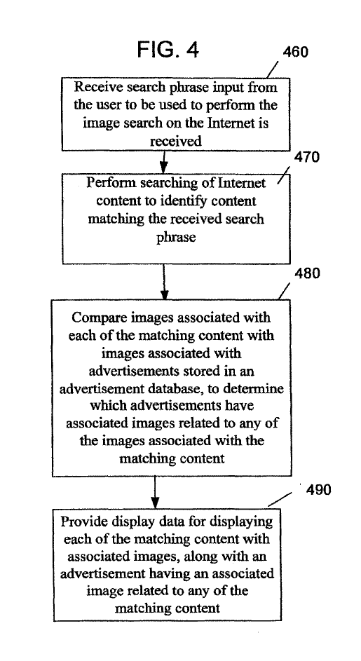

FIG. 4 is a flow chart showing the operations carried out in a method of displaying or combining advertising images with search images according to an illustrative embodiment. At stage 460, a search phrase input from the user to be used to perform the image search online (e.g., on the Internet) is received. The search may be received in any type of search bar, for example a search bar associated with an “everything search” input device 311, a search bar associated with an “image search” input device 312, a search bar associated with a “video search” input device 313, “news” input device 314 and/or “shopping” input device 315, etc. At stage 470, searching of online content is performed to identify content matching the received search phrase. The content may include at least one image comprising metadata terms the same as, similar to, or otherwise related to the terms of the search phrase. At stage 480, images associated with each of the matching content are compared with images associated with advertisements stored in an advertisement database, to determine which advertisements have associated images related to any of the images associated with the matching content. At stage 490, display data is provided for displaying each of the matching content with associated images, along with an advertisement having an associated image related to any of the matching content.

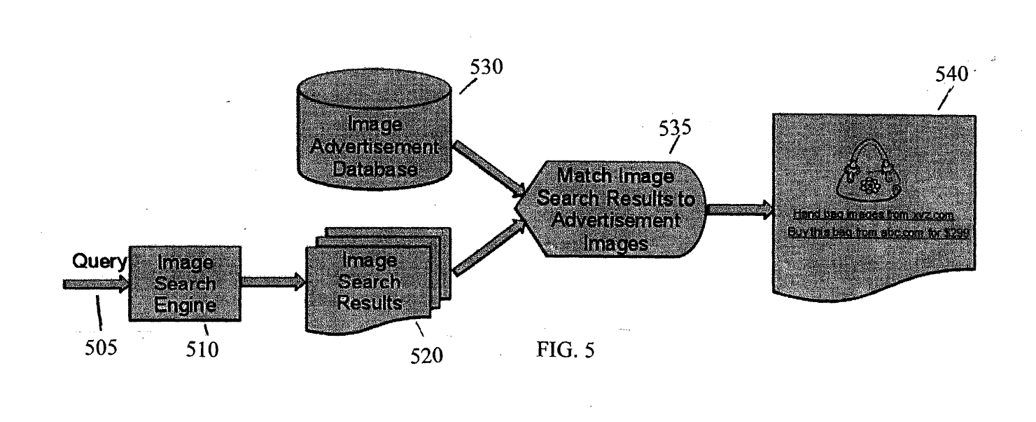

FIG. 5 is a block diagram showing example elements of an advertisement/search results combining or matching system. Each element shown in FIG. 5 may be a circuit (e.g., a programmed portion of a processing circuit), module, unit, or other structure configured to perform the function described. In an embodiment, image search results are combined with image advertisements results during runtime (e.g., real time). An image search query 505 is provided by a user, and is received by an image search engine 510. The image search engine 510 outputs image search results 520 that match the search terms. The image search results 520 are compared with image advertisements stored in an image advertisement database 530 by an image matching unit 535, in which image advertisements that match any of the image search results are retrieved from the image advertisement database 530. A “match” includes not only exact matches but also close matches or other matches determined to meet a predetermined image match threshold. The combination of the image search results 520 and the matching image advertisements obtained from the image advertisement database 530 is provided by the image matching unit 535 to a user in a search results display 540, which can look like the display 300 shown in FIG. 3. In FIG. 5, two separate URLs are provided adjacent each other for a particular image search result that has a matching image advertisement, one being the URL corresponding to where the image search result was obtained, and the other URL corresponding to where the image advertisement web site can be found online. This way, a user can select which URL to use to obtain more information on a particular image that interests him/her.

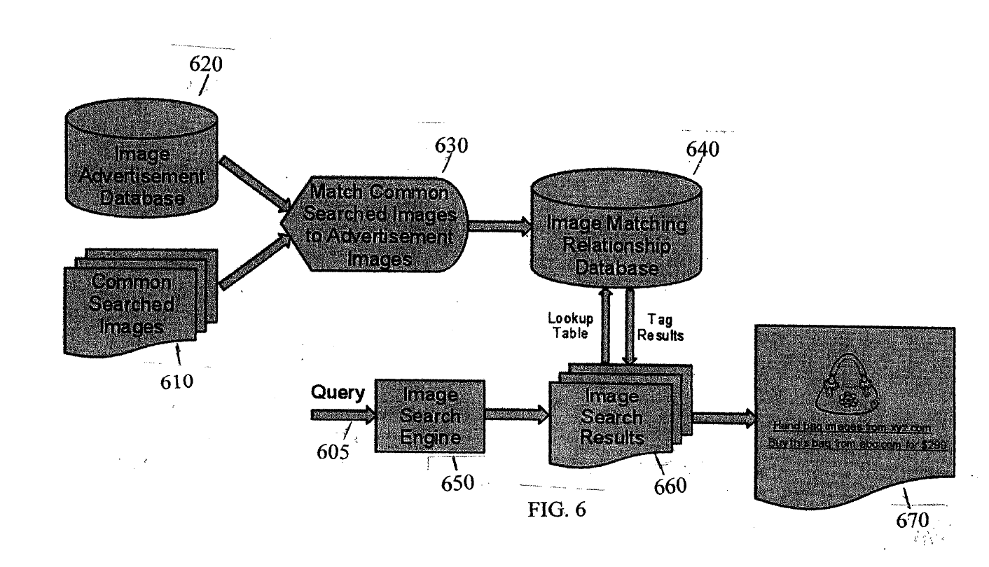

FIG. 6 is a block diagram showing example elements of an advertisement/search results combining or matching system according to an embodiment. Each element shown in FIG. 6 may be a circuit (e.g., a programmed portion of a processing circuit), module, unit, or other structure configured to perform the function described. In this embodiment, image search results are combined with image advertisement results when the system is offline (e.g., non real-time). This provides an easier way to combine image search results with image advertisements stored in an image advertisement database, since there is more time to perform image matching (or a more precise image matching) since that is being performed offline and not while a user is waiting to see the search results. Common searched images 610 are matched with image advertisements stored in an image advertisement database 620, by way of an image matching unit 630. The matched image advertisements and common searched images 610 are stored in an image matching relationship database 640. This can be done in non-real time, e.g., prior to when an image search query is input by a user to an image search engine. When a user inputs an image search query 605 to an image search engine 650, image search results 660 are obtained and stored. The image search results 660 are used to retrieve pertinent information stored in the image matching relationship database 640. In one possible implementation, a lookup table is used to obtain stored common searched images stored in the image matching relationship database 640 with respect to searched images that are output by the image search engine 650. For example, if one of the image search results 660 is a handbag image of a fashion handbag made by a popular fashion handbag company, a lookup table is checked to see if there are any similar handbag images in the common searched images, and if so, if there are any matching image advertisements associated with the popular fashion handbag companies' handbag images. By way of example, a matching handbag advertisement image is tagged with a common searched fashion handbag image in the image matching relationship database 640, and the tagged results are output as additional image search results. The additional image search results are displayed to the user, along with the image search results obtained from the image search engine 650, in an image search results display 670. FIG. 3 shows one possible display screen 300 in which the additional image search results are included with the image search results obtained from the image search engine 650.

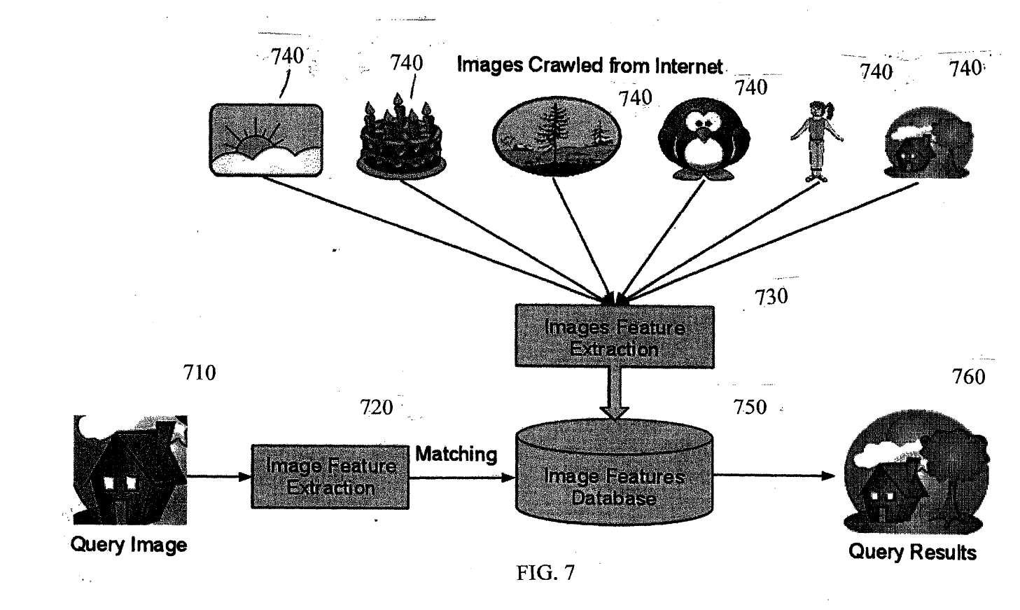

FIG. 7 shows one possible implementation of an image matching process that can be utilized with example embodiments. A query image 710 is provided to a first image feature extraction unit 720, in which image features are extracted from the query image, and in which the image features are stored in an image features database 750. Images 740 crawled from the Internet are retrieved periodically (e.g., hourly, daily, weekly, etc.), and their respective image features are extracted by a second image feature extraction unit 730, in which image features are extracted from the images crawled from the Internet. The image features extracted from the second image feature extraction unit 730 are also stored in the image features database 750. The image features obtained from the query image by the first image extraction unit 720 are matched with the stored image features of images crawled from the Internet stored in the image features database 750, and any matching online images (and the respective URLs of where those online images were obtained) are output as query results 760. The comparison of image features of the query image with the image features of stored online images to determine which ones closely match is a process. Other ways of comparing advertisement images and searched images may be utilized, such as: a) image feature vector extraction and comparison, and b) area pixel density comparison of images. Image matching of advertisement images and searched images may also be performed utilizing Near Duplicate image matching.

In another embodiment, mixed media are combined or matched, such as search images matched with stored video advertisements, to provide a display to the user of pertinent information. In such an embodiment, searched images or searched video (by a user performing an online video search) can be compared to other multimedia content, such as video, music, flash and etc. For example, if one of the obtained video search results from a search engine is a trailer of a newly released movie, then, based on video content matching technology, an advertisement link can be found in an advertisements database and matched to the video result, so that a user can click on the advertisement link to rent a full length movie video or by a movie poster. As another example, if a user requests an image search of a popular singer, the third embodiment may provide to the user music content associated with the popular singer, to be displayed together with searched images of the popular singer found online. Video content matching technology may be such that any portion (e.g., a frame) of an advertisement video that closely matches a searched image is considered to be a “hit” and added to the search results presented to the user.

The advertisement management system 110, the performance analysis apparatus 120, elements of system 500, or other elements described herein can be realized by instructions embodied in a tangible medium that upon execution cause one or more processing devices to carry out the processes and functions described above. Such instructions can comprise, for example, interpreted instructions, such as script instructions, e.g., JavaScript™ or ECMAScript instructions, or executable code, or other instructions stored in a computer readable medium. The advertisement management system 110 and/or the performance analysis apparatus 120 can be distributively implemented over a network, such as a server farm, or can be implemented in a single computer device. Some or all of the elements shown in FIG. 5, FIG. 6 and FIG. 7 can be realized by instructions that upon execution cause one or more processing devices to carry out the processes and functions described above.

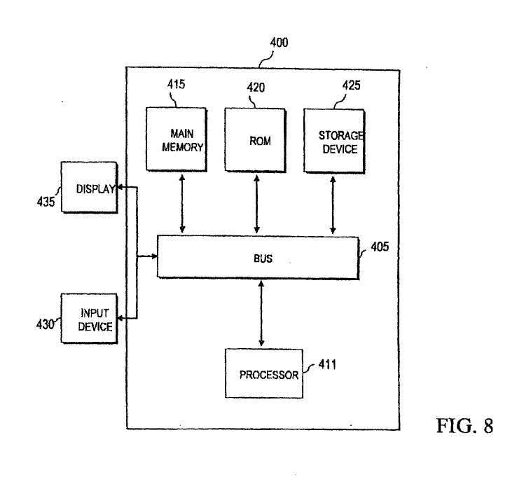

FIG. 8 illustrates a depiction of a computer system 400 that can be used to provide user interaction reports, process log files, implement an illustrative performance analysis apparatus 120, and/or implement an illustrative advertisement management system 110. The computing system 400 includes a bus 405 or other communication mechanism for communicating information and a processor 411 coupled to the bus 405 for processing information. The computing system 400 also includes main memory 415, such as a random access memory (RAM) or other dynamic storage device, coupled to the bus 405 for storing information, and instructions to be executed by the processor 411. Main memory 415 can also be used for storing position information, temporary variables, or other intermediate information during execution of instructions by the processor 411. The computing system 400 may further include a read only memory (ROM) 420 or other static storage device coupled to the bus 405 for storing static information and instructions for the processor 411. A storage device 425, such as a solid state device, magnetic disk or optical disk, is coupled to the bus 405 for persistently storing information and instructions.

The computing system 400 may be coupled via the bus 405 to a display 435, such as a liquid crystal display, or active matrix display, for displaying information to a user. An input device 430, such as a keyboard including alphanumeric and other keys, may be coupled to the bus 405 for communicating information, and command selections to the processor 411. In an embodiment, the input device 430 has a touch screen display 435. The input device 430 can include a cursor control, such as a mouse, a trackball, or cursor direction keys, for communicating direction information and command selections to the processor 411 and for controlling cursor movement on the display 435.

According to various embodiments, the processes that effectuate illustrative embodiments that are described herein can be implemented by the computing system 400 in response to the processor 411 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors in a multi-processing arrangement may also be employed to execute the instructions contained in main memory 415. In alternative embodiments, hard-wired circuitry may be used in place of or in combination with software instructions to implement illustrative embodiments. Thus, embodiments are not limited to any specific combination of hardware circuitry and software. By way of example and not by way of limitation, referring to FIGS. 5-8, the image matching units 535 and 630, the image search engines 510 and 650, and the image feature extraction units 720 of FIGS. 5-7 may be implemented by the processor 411 of FIG. 8; the databases 530, 620, 640 and 750 of FIGS. 5-7 may be implemented by the main memory 415 and/or storage device 425 of FIG. 8; and the displays 540, 670 and 760 of FIGS. 5-7 may be implemented by the display 435 of FIG. 8.

In another embodiment, instead of the user initiating a search by entering a search phrase to perform a search of a particular media type or media types, information can be pushed to the user history information. The user history information can be, for example, information corresponding to web sites visited by the user within the current user session or the last few user sessions. For example, if the user visits a first fashion handbag company web site and a second fashion handbag company web site, then advertisement data of the first and second fashion companies and other high-end handbag manufacturers can be pushed to the user when the user visits one or more of these web sites during a user session. Thus, instead of information being pulled from a user based on input by the search (e.g., a key word search input), in which relevant advertisements are matched with searched information of a particular media type, in this other embodiment, relevant advertisement information is pushed to the user based on a history of web sites which the user has visited recently. In one particular implementation of this embodiment and referring to the example above, the history information is used to push high priced handbag advertisements to the user together with search results obtained from a search request made by the user, even when the search request is unrelated to high priced handbags. So, if the user requested search results to be performed on a particular professional football team, and whereby the user had previously visited the first and second fashion handbag company web pages prior to conducting the search, relevant advertisements may be pushed to the user in a search results display screen, in which those advertisements are directed to handbags made by the first and second fashion companies that are related to the particular professional football team (e.g., have that team's logo somewhere on the handbag).

Although an example processing system has been described in FIG. 8, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. For example, while certain embodiments have been described with respect to searching of a single media type, i.e., image search or video search, one or more embodiments are also relevant to a generic search where the search results are blended with different media types. Thus, for example, a user can type in a keyword search phrase into an Internet search engine and obtains results that contain images, video and other media types blended with text results, and in which relevant matching advertisements are obtained (and provided to the user) that match one or more of these multi-media search results. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method of providing advertising content in response to an image search request to be performed online, the method comprising:
receiving information associated with a search input to be used to perform the online image search;
identifying online content matching the search input;
comparing images associated with the matching content with images associated with advertisements stored in an advertisement database, to determine which of the stored advertisements have associated images related to any of the images associated with the matching content; and
providing display data used for displaying each of the matching content with associated images, along with an advertisement having an associated image related to any of the matching content.

2. The method of claim 1, wherein data is provided for displaying each advertisement together with the associated matching content by providing data for displaying at least one user input field that can be selected by the user in the vicinity of the image associated with the matching content, the at least one user input field corresponding to one or more of an Internet address of the matching content and a web site that provided the associated advertisement for storage in the advertisement database.

3. A method of providing advertising content in response to a search request of at least a first media type to be performed online, comprising:
receiving information associated with a search input to be used to perform the online search of the at least the first media type;
determining online content of the at least first media type that matches the search input;
comparing online content of the at least the first media type associated with each of the matching content with content of a second media type associated with advertisements stored in an advertisement database, to determine which of the advertisements have associated content of the second media type related to any of the online content of the at least the first media type associated with the matching content; and
providing display data used for displaying each of the matching content with associated data of the at least the first media type, along with each advertisement having associated content of the second media type that is related to any of the matching content.

4. The method of claim 3, wherein the at least the first media type includes the first media type and a third media type different from the first media type.

5. The method of claim 4, wherein the first and second media types are image media.

6. The method of claim 4, wherein the first and second media types are video media.

7. The method of claim 3, wherein the first media type and the second media type are different media types.

8. The method of claim 7, wherein the first media type is image media and the second media type is video media.

9. The method of claim 7, wherein the first media type is video media and the second media type is image media.

10. A computer readable medium having a computer program encoded therein, which, when executed by at least one computer, causes the computer to combine relevant image search results with image advertisements for display to a user, by performing the functions of:
receiving information associated with a search input to be used to perform the online image search;
identifying online content matching the search input;
comparing images associated with the matching content with images associated with advertisements stored in an advertisement database, to determine which of the stored advertisements have associated images related to any of the images associated with the matching content; and
providing display data used for displaying each of the matching content with associated images, along with an advertisement having an associated image related to any of the matching content.

11. The computer readable medium of claim 10, wherein data is provided for displaying each advertisement together with the associated matching content by providing data for displaying at least one user input field that can be selected by the user in the vicinity of the image associated with the matching content, the at least one user input field corresponding to one or more of an Internet address of the matching content and a web site that provided the associated advertisement for storage in the advertisement database.

12. A computer readable medium having a computer program encoded therein, which, when executed by at least one computer, causes the computer to combine relevant image search results with image advertisements for display to a user, by performing the functions of:
receiving information associated with a search input to be used to perform the online search of the at least the first media type;
determining online content of the at least first media type that matches the search input;
comparing online content of the at least the first media type associated with each of the matching content with content of a second media type associated with advertisements stored in an advertisement database, to determine which of the advertisements have associated content of the second media type related to any of the online content of the at least the first media type associated with the matching content; and
providing display data used for displaying each of the matching content with associated data of the at least the first media type, along with each advertisement having associated content of the second media type that is related to any of the matching content.

13. The computer readable medium of claim 12, wherein the at least the first media type includes the first media type and a third media type different from the first media type.

14. The computer readable medium of claim 13, wherein the first and second media types are image media.

15. The computer readable medium of claim 13, wherein the first and second media types are video media.

16. The computer readable medium of claim 12, wherein the first media type and the second media type are different media types.

17. The computer readable medium of claim 16, wherein the first media type is image media and the second media type is video media.

18. The computer readable medium of claim 16, wherein the first media type is video media and the second media type is image media.

19. An apparatus configured to provide advertising content in response to a search request of at least a first media type to be performed online, comprising:
an input unit configured to receive a search input to be used to perform the search of the at least the first media type online;
a search unit configured to perform searching of online content of the at least the first media type to determine which of the online content matches the received search input;
a comparing unit configured to compare online content of the at least the first media type associated with each of the matching content with content of a second media type associated with advertisements stored in an advertisement database, to determine which of the advertisements have associated content of the second media type related to any of the online content of the at least the first media type associated with the matching content; and
a display information providing unit configured to provide display information used for displaying each of the matching content with associated data of the at least the first media type, along with each advertisement having associated content of the second media type that is related to any of the matching content.

20. The apparatus of claim 19, wherein, based on receipt of the display information by a client computer, each advertisement is displayed at the client computer together with the associated matching content by displaying at least one user input field that can be selected by the user in the vicinity of the image associated with the matching content, the at least one user input field corresponding to one or more of an Internet address of the matching content and a web site that provided the associated advertisement for storage in the advertisement database.
